(19) United States
(12) Patent Application Publication
(10) Pub. No.: US 2006/0238471 A1
(43) Pub. Date: Oct. 26, 2006

(54) Driving device and driving method for a display

(76) Inventors: Byoung-Suk Kim, Seoul (KR); Myeong-Su Kim, Suwon-city (KR)

Correspondence Address: CANTOR COLBURN, LLP, 55 GRIFFIN ROAD SOUTH, BLOOMFIELD, CT, 06002, US

(21) Appl. No.: 11/374,717

(22) Filed: Mar. 14, 2006

(30) Foreign Application Priority Data
Apr. 22, 2005 (KR) 10-2005-0033569

(51) Int. Cl. G09G 3/36

(52) U.S. Cl. 345/89

(57) ABSTRACT

A driving device and driving method for a display is provided that enhances the difference between the brightness displayed by the low gray-scale data and the brightness displayed by the high gray-scale data. The driving device and method include dividing input gray-scale data into high gray-scale output data and low gray-scale output data and allowing brightness higher than the brightness in the highest gray scale to be displayed by the use of the high gray-scale output data. Accordingly, side visibility of the display is enhanced and a display characteristic of a display is improved. In addition, the driving device and driving method includes enhancing an AVDD voltage applied to a gray-scale voltage generator to prevent the brightness of the display from decreasing as a whole.

This application claims priority to Korean Patent Application No. 10-2005-0033569, filed on Apr. 22, 2005 and all the benefits accruing therefrom under 35 U.S.C. §119, and the contents of which in its entirety are herein incorporated by reference.

### BACKGROUND OF THE INVENTION

(a) Field of the Invention

The present invention relates to a driving device and a driving method for a display which improve visibility so as to exhibit no difference between side visibility and front visibility of an image on the display, and which display an image with improved image quality.

(b) Description of the Related Art

A liquid crystal display, including commonly used flat panel displays, includes two panels (e.g., an upper panel and a lower panel) having electric field generating electrodes, such as pixel electrodes and a common electrode, and a liquid crystal layer interposed between the two panels. The liquid crystal display displays an image by applying a voltage to the electric field generating electrodes, thus generating an electric field in the liquid crystal layer, in which the voltage to the electric field generating electrodes determines an alignment of liquid crystal molecules in the liquid crystal layer to control polarization of incident light.

Among such liquid crystal displays, a liquid crystal display with a vertical alignment mode includes liquid crystal molecules arranged such that major axes of the liquid crystal molecules are perpendicular relative to surfaces defining the upper and lower panels when no electric field is generated. This state of such a liquid crystal display has attracted much attention, since the liquid crystal display in this state has a high contrast ratio and easily provides a wide reference viewing angle. Here, the reference viewing angle means a viewing angle having a contrast ratio of 1:10 or an effective angle in inversion of brightness between gray scales.

A method of forming cut portions in the electric field generating electrodes and a method of forming protrusions on the electric field generating electrodes are currently known methods of embodying a wide viewing angle in a liquid crystal display with a vertical alignment mode. Since the direction in which the liquid crystal molecules are tilted can be determined by the use of the cut portions and the protrusions, the reference viewing angle can be widened by variously arranging the cut portions and the protrusions to distribute the tilt direction of the liquid crystal molecules in various directions.

However, the liquid crystal display with a vertical alignment mode has better front visibility than side visibility. For example, in the case of a liquid crystal display with a patterned vertical alignment (PVA) mode having the cut portions, an image becomes brighter toward the side, and in some cases the difference in brightness between high gray scales may disappear causing a vague profile of the image.

In order to enhance the side visibility, a method has been suggested of dividing a pixel into two subpixels and applying different voltages to the two subpixels. The two subpixels are coupled to each other in a capacitive manner and the voltages applied to the two subpixels are different from each other. The voltages are different from each other by directly applying a voltage to one subpixel and causing a voltage drop in the other subpixel due to the capacitive coupling, thereby causing different transmissivities.

Currently in the above method, a high voltage is applied to one of the two subpixels while a low voltage is applied to the other one. The high voltage and the low voltage appear with reference to the entire gamma curve of the liquid crystal display. However, since a voltage greater than the voltage indicating the highest brightness in the gamma curve cannot be applied, the enhancement in visibility is limited.

### BRIEF SUMMARY OF THE INVENTION

The present invention provides a driving device and a driving method for a display which improve uniform visibility by exhibiting no difference between side visibility and front visibility and which an image is displayed with improved image quality.

According to an aspect of the present invention, there is provided a driving device of a display including a plurality of pixels arranged in a matrix, each pixel having a pixel electrode. The driving device includes: a signal controller for receiving input image data and converting the input image data into first output image data having a gray scale higher than a gray scale of the input image data and second output image data having a gray scale lower than the gray scale of the input image data; and a data driver for converting the first and second output image data from the signal controller into first and second data voltages and applying the first and second data voltages to the corresponding pixels, wherein the first output image data include data for displaying brightness higher than the brightness in the highest gray scale.

The first output image data and the second output image data may be supplied to neighboring pixel electrodes every frame.

In this case, each pixel electrode may be divided into a first subpixel electrode and a second subpixel electrode, and the first output image data and the second output image data may be supplied to the first subpixel electrode and the second subpixel electrode every frame, respectively.

The driving device may further comprise a gray-scale voltage generator for dividing an input AVDD voltage with a resistor and generating a gray scale voltage. Here, the AVDD voltage may be higher than the gray scale voltage in the highest gray scale.

The gray-scale voltage generator may include a section for generating a gray scale voltage for the first output image data and a section for generating a gray scale voltage for the second output image data.

According to another aspect of the present invention, there is provided a driving device of a display having a plurality of pixels arranged in a matrix, each pixel having a pixel electrode. The driving device includes: a signal controller for converting input image data into output image data and outputting the output image data; a first gray-scale voltage generator for generating a gray scale voltage by dividing a first AVDD voltage with a first resistor and generating a first gray scale voltage for displaying a first gray scale higher than the gray scale of the input image data; a second gray-scale voltage generator for generating a gray scale voltage by dividing a second AVDD voltage with a second resistor and generating a second gray scale voltage for displaying a second gray scale lower than the gray scale of the input image data; and a data driver for converting the first and second gray scale voltages from the first gray-scale voltage generator and the second gray-scale voltage generator into first and second data voltages, respectively, on the basis of the output image data from the signal controller and applying the first and second data voltages to the corresponding pixels, wherein the first gray scale voltage has a voltage value for displaying brightness higher than the brightness in the highest gray scale.

The first data voltage and the second data voltage may be applied to the neighboring pixel electrodes every frame. Alternatively, each pixel electrode may be divided into first and second subpixel electrodes, and the first data voltage and the second data voltage may be applied to the first and second subpixel electrodes every frame, respectively.

The first AVDD voltage may be higher than the gray scale voltage in the highest gray scale.

According to another aspect of the present invention, there is provided a driving device of a display having a plurality of pixels arranged in a matrix, each pixel having a pixel electrode. The driving device includes: a signal controller for converting input image data into output image data and outputting the output image data; a gray-scale voltage generator for generating a gray scale voltage by dividing an AVDD voltage with a resistor; and a data driver for converting the gray scale voltage from the gray-scale voltage generator into first and second data voltages on the basis of the output image data from the signal controller and applying the first and second data voltages to the corresponding pixels, wherein the first data voltage has a voltage value for displaying brightness higher than the brightness in the highest gray scale.

According to another aspect of the present invention, there is provided a method for driving a display having a plurality of pixels arranged in a matrix, each pixel having a pixel electrode. The method includes: receiving input image data; converting the input image data into first output image data having a gray scale higher than the gray scale of the input image data and second output image data having a gray scale lower than the gray scale of the input image data; converting the first and second output image data into first and second data voltages; and applying the first and second data voltages to the corresponding pixels, wherein the first output image data include data for displaying brightness higher than the brightness in the highest gray scale.

According to another aspect of the present invention, there is provided a method for driving a display having a plurality of pixels arranged in a matrix, each pixel having a pixel electrode. The method includes: converting input image data into output image data; outputting the output image data; generating a gray scale voltage by dividing a first AVDD voltage with a resistor and generating a first gray scale voltage for displaying a gray scale higher than the gray scales of the input image data; generating a gray scale voltage by dividing a second AVDD voltage with a resistor and generating a second gray scale voltage for displaying a gray scale lower than the gray scale of the input image data; and converting the first and second gray scale voltages from the first gray-scale voltage generator and the second gray-scale voltage generator into first and second data voltages on the basis of the output image data; and applying the first and second data voltages to the corresponding pixels, wherein the first gray scale voltage has a voltage value for displaying brightness higher than the brightness in the highest gray scale.

According to yet another aspect of the present invention, there is provided a method for driving a display having a plurality of pixels arranged in a matrix, each pixel having a pixel electrode. The method includes: converting input image data into output image data; outputting the output image data; generating a gray scale voltage by dividing an AVDD voltage with a resistor; and converting the gray scale voltage into first and second data voltages on the basis of the output image data; and applying the first and second data voltages to the corresponding pixels, wherein the first data voltage has a voltage value for displaying brightness higher than the brightness in the highest gray scale.

### BRIEF DESCRIPTION OF THE DRAWINGS

The above and other features and advantages of the present invention will become more apparent by describing exemplary embodiments thereof in detail with reference to the attached drawings, in which:

FIG. 1 is a block diagram illustrating a liquid crystal display according to an exemplary embodiment of the present invention;

FIG. 2 is a schematic circuit diagram of a pixel of the liquid crystal display of FIG. 1 according to an exemplary embodiment of the present invention;

FIG. 3 is a graph illustrating a high gray-scale gamma curve, a low gray-scale gamma curve and an original gamma curve according to an exemplary embodiment of the present invention;

FIG. 4 is a diagram illustrating relations between high and low gray-scale output data values to be supplied and gray scales to be displayed according to an exemplary embodiment of the present invention;

FIG. 5 is a plan view illustrating a pixel structure in which a pixel is divided into two subpixels according to an exemplary embodiment of the present invention;

FIG. 6 is a plan view illustrating another pixel structure of two neighboring pixels according to another exemplary embodiment of the present invention; and

FIG. 7 is a circuit diagram illustrating a gray-scale voltage generator according to an exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present. For example, if it is mentioned that a layer, a film, an area, or a plate is placed on a different element, it includes a case that the layer, film, area, or plate is placed right on the different element, as well as a case that another element is disposed therebetween. In contrast for example, if it is mentioned that one element is placed right on another element, it means that no element is disposed therebetween.

In the drawings, thicknesses are enlarged for the purpose of clearly illustrating layers and areas. In addition, like elements are denoted by like reference numerals in the specification. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

In exemplary embodiments of the present invention, it is possible to enhance the difference between the brightness displayed by the low gray-scale data and the brightness displayed by the high gray-scale data by dividing input gray-scale data into high gray-scale data and low gray-scale data, and by allowing brightness higher than the brightness in the highest gray scale to be displayed by the use of the high gray-scale data.

Hereinafter, exemplary embodiments of the present invention will be described in detail with reference to the attached drawings such that exemplary embodiments of the present invention can be easily practiced by those skilled in the art. However, the present invention is not limited to the exemplary embodiments described herein and may be embodied in various forms as recognized by those skilled in the pertinent art.

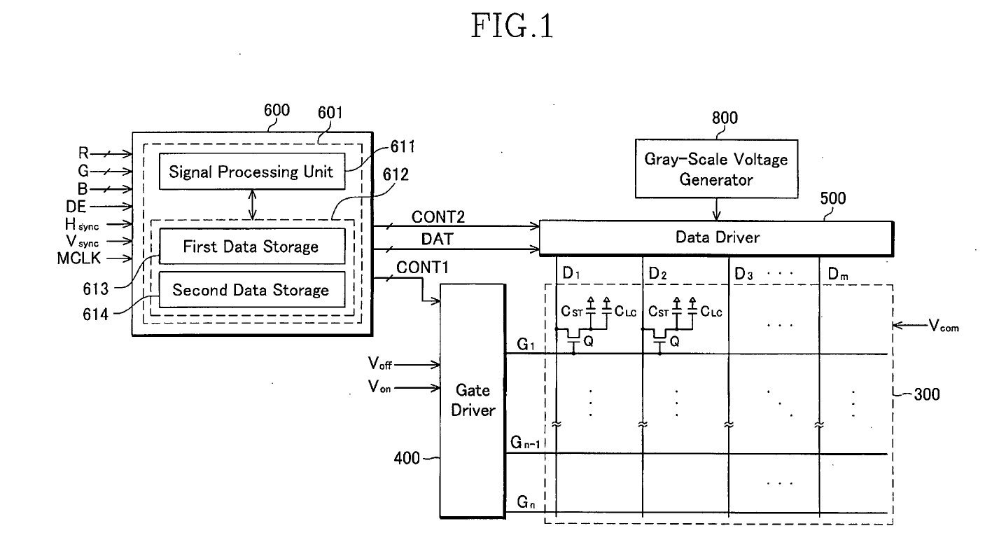

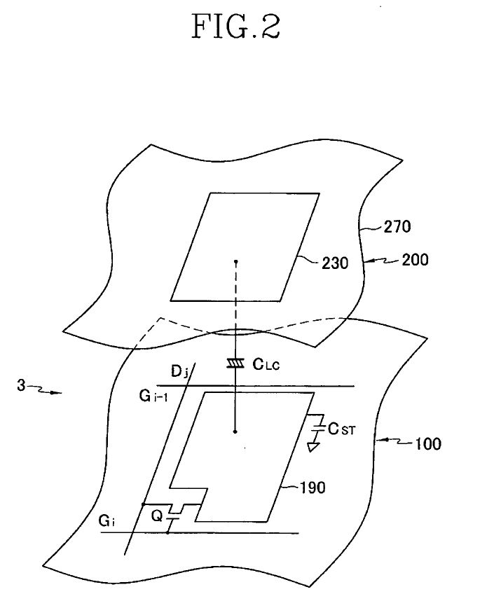

A liquid crystal display according to an exemplary embodiment of the present invention will be now described in detail with reference to FIGS. 1 and 2.

FIG. 1 is a block diagram illustrating a liquid crystal display according to an exemplary embodiment of the present invention, and FIG. 2 is an equivalent circuit diagram of a pixel of the liquid crystal display of FIG. 1.

As shown in FIG. 1, the liquid crystal display according to an embodiment of the present invention includes a liquid crystal panel assembly 300, a gate driver 400 and a data driver 500 connected to the liquid crystal panel assembly 300, a gray-scale voltage generator 800 connected to the data driver 500 and a signal controller 600, which controls all of the above-mentioned units.

The liquid crystal panel assembly 300 includes a plurality of display signal lines G₁ to Gₙ and D₁ to Dₘ and a plurality of pixels, which are connected to the plurality of display signal lines and arranged approximately in a matrix, as seen in the equivalent circuit diagram. The liquid crystal panel assembly 300 includes lower and upper panels 100 and 200, respectively, opposed to each other and a liquid crystal layer 3 intermediate the lower and upper panels 100 and 200.

The display signal lines G₁ to Gₙ and D₁ to Dₘ include a plurality of gate lines G₁ to Gₙ for delivering gate signals (also referred to as “scan signals”) and a plurality of data lines D₁ to Dₘ for delivering data signals. The gate lines G₁ to Gₙ extend approximately in rows or in a horizontal direction and are substantially parallel to each other. The data lines D₁ to Dₘ extend approximately in columns or in a vertical direction and are substantially parallel to each other, as illustrated in FIG. 1.

Each pixel, defined by the i-th gate line Gᵢ and the j-th data line Dⱼ, for example, includes a switching element Q connected to the corresponding gate line Gᵢ, the corresponding data line Dⱼ, a liquid crystal capacitor C_{LC} and a storage capacitor C_{ST}. The storage capacitor C_{ST} may be omitted as needed.

The switching element Q of each pixel, such as a thin film transistor provided on the lower panel 100, is a three-terminal switching element having a control terminal connected to the corresponding gate line G₁ to Gₙ, an input terminal connected to the corresponding data line D₁ to Dₘ and an output terminal connected to both the liquid crystal capacitor C_{LC} and the storage capacitor C_{ST}.

The liquid crystal capacitor C_{LC} includes a pixel electrode 190 of the lower panel 100 and a common electrode 270 of the upper panel 200 as two electrodes. The liquid crystal layer 3 between the two electrodes 190 and 270 serves as a dielectric substance. The pixel electrode 190 is connected to the switching element Q. The common electrode 270 is formed on the entire surface of the upper panel 200 and is supplied with a common voltage V_{com}. Alternatively, the common electrode 270 may be formed on the lower panel 100, unlike the case illustrated in FIG. 2. In this case, at least one of the two electrodes 190 and 270 may be formed in a line shape or a bar shape.

The storage capacitor CST serves to assist the liquid crystal capacitor C_{LC}, and is formed by forming an additional signal line (not shown) on the lower panel 100 and the pixel electrode 190 to overlap with each other with an insulating substance therebetween. The additional signal line is supplied with a predetermined voltage such as the common voltage V_{com}. However, the storage capacitor C_{ST} may be formed by allowing the pixel electrode 190 to overlap with a previous gate line directly on the pixel electrode with the insulation substance therebetween.

In order to embody a color display, a desired color can be displayed through a spatial and/or temporal sum of the primary colors. For example, a desired color can be displayed using spatial division by allowing each pixel to uniquely display one of the primary colors or using temporal division by allowing each pixel to display the primary colors in turn with the passage of time (temporal division). Examples of the primary colors include the three primary colors of red, green and blue in exemplary embodiments.

FIG. 2 shows an example of the spatial division in which each pixel includes a color filter 230 displaying one of red, green, and blue colors on the upper panel 200. The color filter 230 may also be formed on or under the pixel electrode 190 on the lower panel 100, unlike the case illustrated in FIG. 2.

A polarizer (not shown) for polarizing light is attached to the outer surface of at least one of the two panels 100 and 200 of the liquid crystal panel assembly 300.

Referring again to FIG. 1, the gray scale generator 800 generates two sets of gray scale voltages relating to transmissivity of the pixels. One set of gray scale voltages has a positive value and the other set has a negative value, relative to the common voltage V_{com}.

The gate driver 400 is connected to the gate lines G₁ to Gₙ of the liquid crystal panel assembly 300. The gate driver 400 supplies a gate signal, which is obtained by combining a gate-on voltage Vₒₙ and a gate-off voltage V_{off} from the outside, to the gate lines G₁ to Gₙ.

The data driver 500 is connected to the data lines D₁ to Dₘ of the liquid crystal panel assembly 300. The data driver 500 selects and supplies the gray scale voltages from the gray-scale voltage generator 800 as data signals to the pixels.

The gate driver 400 and/or the data driver 500 may be mounted directly on the liquid crystal panel assembly 300 in the form of a plurality of driver IC chips. Alternatively, the gate driver 400 and/or the data driver 500 may be mounted on a flexible printed circuit film (not shown) and the flexible printed circuit film may be attached to the liquid crystal panel assembly 300 in the form of a tape carrier package (TCP). Alternatively, the gate driver 400 and/or the data driver 500 may be integrated on the liquid crystal panel assembly 300 together with the display signal lines G₁ to Gₙ and D₁ to Dₘ and the thin film transistor switching elements Q.

The signal controller 600 includes an image data correcting unit 601, which controls operations of the gate driver 400 and the data driver 500. Now, operations of the liquid crystal display will be described in detail.

The signal controller 600 is supplied with input image signals R, G and B and input control signals for controlling display of the input image signals R, G and B, such as a vertical synchronization signal V_{sync}, a horizontal synchronization signal H_{sync}, a main clock signal MCLK and a data enable signal DE, from an external graphics controller (not shown). The signal controller 600 appropriately processes the input image signals R, G and B in accordance with operational conditions of the liquid crystal panel assembly 300 on the basis of the input image signals R, G and B and the input control signals. The signal controller 600 generates a gate control signal CONT1, a data control signal CONT2 and processed image signals (e.g., image data “DAT”). The signal controller 600 supplies the gate control signal CONT1 to the gate driver 400 and supplies the data control signal CONT2 and the processed image signals DAT to the data driver 500.

The gate control signal CONT1 includes a vertical synchronization start signal STV for instructing the start of scanning and includes at least one clock signal for controlling the output time of the gate-on voltage Vₒₙ. The gate control signal CONT1 may include an output enable signal OE defining the retaining time of the gate-on signal Vₒₙ.

The data control signal CONT2 includes a horizontal synchronization start signal STH for indicating the transmission of data to the pixels in one row, a load signal LOAD for instructing to apply the corresponding data voltages to the data lines D₁ to Dₘ and a data clock signal HCLK. The data control signal CONT2 may include an inversion signal RVS for instructing to invert the polarity of the data voltage with respect to the common voltage V_{com} (hereinafter, “polarity of the data voltage with respect to the common voltage” is referred to as “polarity of the data voltage”).

In response to the data control signal CONT2 from the signal controller 600, the data driver 500 receives the image data DAT for the pixels in a row. The data driver 500 converts the image data DAT into an analog data voltage by selecting the gray scale voltage corresponding to the image data DAT among the gray scale voltages from the gray-scale voltage generator 800. The data driver 500 then supplies the analog data voltage to the corresponding data lines D₁ to Dₘ.

The gate driver 400 sequentially supplies the gate-on voltage Vₒₙ to the gate lines G₁ to Gₙ in response to the gate control signal CONT1 from the signal controller 600 to turn on the switching elements Q connected to the gate lines G₁ to Gₙ. Accordingly, the data voltage supplied to the data lines D₁ to Dₘ is applied to the corresponding pixels through the turned-on switching elements Q.

The difference between the data voltage applied to a pixel and the common voltage V_{com} appears as a charged voltage of the liquid crystal capacitor C_{LC}, that is, a pixel voltage. Liquid crystal molecules of the liquid crystal layer 3 vary in alignment depending upon the magnitude of the pixel voltage, and the light passing through the liquid crystal layer 3 varies in polarization. The variation in polarization appears as a variation in light transmissivity by means of the polarizer (not shown) attached to the panels 100 and 200, whereby the brightness of the pixel is determined.

When one horizontal period (or “1H”) (which is one period of the horizontal synchronization signal H_{sync} and the data enable signal DE) has passed, the data driver 500 and the gate driver 400 repeat the same operations for the pixels in the next row. In this way, the gate-on voltage Vₒₙ is sequentially applied to all of the gate lines G₁ to Gₙ for one frame, thereby applying the data voltage to all of the pixels. The next frame is started after one frame is ended and the status of the inversion signal RVS supplied to the data driver 500 is controlled so that the polarity of the data voltage applied to the respective pixels is inverted for every predetermined frame (“frame inversion”). At this time, in one frame, the polarity of the data voltage supplied through one data line may be inverted (for example, “row inversion”, “dot inversion”) or the polarities of the data voltages supplied through the neighboring data lines may be opposite to each other (for example, “column inversion”, “dot inversion”), depending upon the characteristic of the inversion signal RVS.

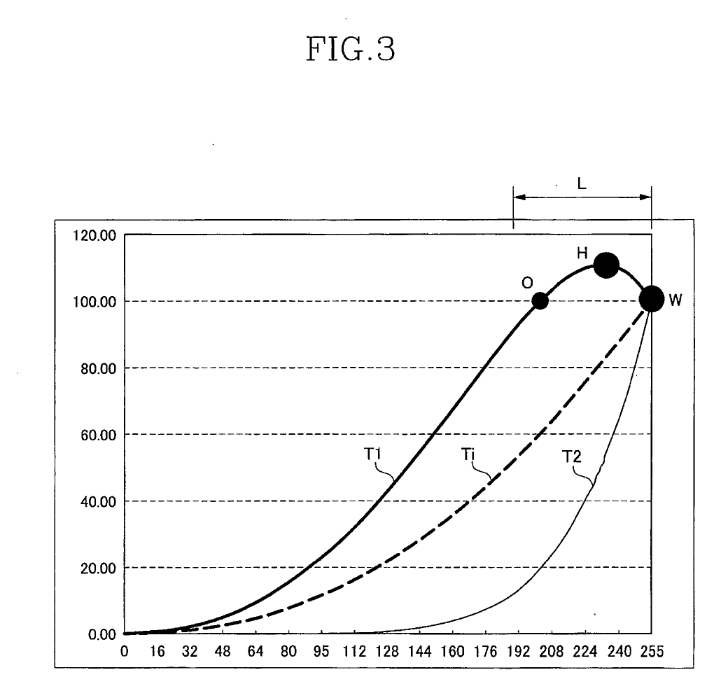

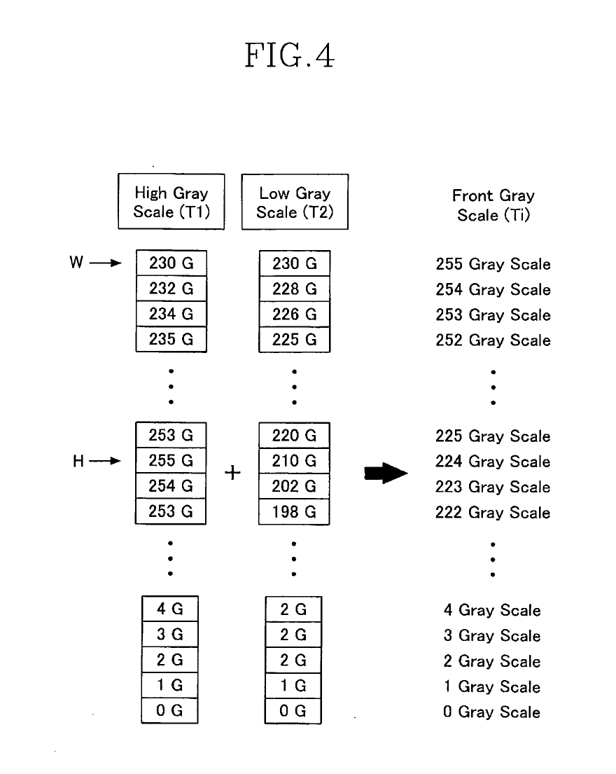

A data process performed by the signal controller 600 according to the embodiment of the present invention will now be described in detail with reference to FIGS. 3 and 4.

FIG. 3 is a graph illustrating a high gray-scale gamma curve, a low gray-scale gamma curve and an original gamma curve according to an exemplary embodiment of the present invention. FIG. 4 is a diagram illustrating relations between high and low gray-scale output data values to be supplied and gray scales to be displayed according to an exemplary embodiment of the present invention.

As described with reference to FIG. 1, the signal controller 600 includes the image data correcting unit 601. The image data correcting unit 601 includes a signal processor 611 and a data storage unit 612 connected to the signal processor 611, as depicted with the double-ended arrow therebetween. The data storage unit 612 includes first and second data storages 613 and 614, respectively.

The first and second data storages 613 and 614 may be storage units such as read only memories (ROMs) and random access memories (RAMs), or they may be lookup tables. However, embodiments of the present invention are not limited to this example, and a variety of storage elements may be employed.

The first and second data storages 613 and 614 store conversion data corresponding to the image data having gray scales, respectively. The conversion data stored in the first data storage 613 has a gray scale higher than that of the original image data (hereinafter, referred to as “high gray-scale conversion data”). The conversion data stored in the second data storage 614 has a gray scale lower than that of the original image data (hereinafter, referred to as “low gray-scale conversion data”).

A function of the brightness displayed with the gray scale of the high gray-scale conversion data with respect to the original image data forms the curve T1 shown in FIG. 3 (hereinafter, referred to as “high gray-scale gamma curve”), and a function of the brightness displayed with the gray scale of the low gray-scale conversion data with respect to the original image data forms the curve T2 shown in FIG. 3 (hereinafter, referred to as “low gray-scale gamma curve”). The curve Ti is a curve in which the brightness displayed with the gray scale of the original image data is expressed as a function of a gray scale (hereinafter, referred to as “original gamma curve”).

Here, it is ideally preferable that a curve resulting from averaging the high gray-scale gamma curve T1 and the low gray-scale gamma curve T2 is the original gamma curve Ti. The average may mean averaging the high gray-scale gamma curve T1 and the low gray-scale gamma curve T2 in a one-to-one ratio without any weighting value, or it may mean averaging the high gray-scale gamma curve T1 and the low gray-scale gamma curve T2 by weighting either one, for example, by weighting the low gray-scale gamma curve T2.

The brightness of the liquid crystal display can vary depending upon the viewing angle of viewing the liquid crystal display. The gamma curve may vary accordingly, depending upon the viewing angle of viewing the liquid crystal display. Therefore, at all angles, it is difficult for the average of the high gray-scale gamma curve T1 and the low gray-scale gamma curve T2 to become the original gamma curve Ti, and it is preferable that the high gray-scale conversion data and the low gray-scale conversion data are determined so as to satisfy such a relation as viewed at the front side. It is also preferable that the high gray-scale conversion data and the low gray-scale conversion data are determined such that the average of the high gray-scale gamma curve T1 and the low gray-scale gamma curve T2 is closer to the original gamma curve Ti as viewed at another angle, that is, at a specific reference angle.

On the other hand, a gray scale region (L) (hereinafter, referred to as “excessive brightness region”) in which brightness higher than the highest brightness (brightness at a point W) of the original gamma curve Ti can be displayed exists in the high gray-scale gamma curve. The reason for allowing the high gray-scale data to have the excessive brightness region (L) is as follows. Generally, the data voltages are applied to the corresponding pixels by dividing the input image data into the high gray-scale data and the low gray-scale data, converting the high gray-scale data and the low gray-scale data into the output image data and supplying the output image data to the data driver. At this time, the side visibility is enhanced by matching the high gray-scale gamma curve T1 and the low gray-scale gamma curve T2 with the front gamma curve Ti. As the difference in brightness between the high gray-scale gamma curve T1 and the low gray-scale gamma curve T2 becomes larger, the side visibility and the display characteristics are improved.

Referring again to FIG. 1, the signal processor 611 of the signal controller 600 reads the conversion data corresponding to the input image data R, G and B from the first data storage 613 and the second data storage 614 of the data storage unit 612, and outputs the conversion data as the output image data. Hereinafter, the output image data read from the first data storage 613 are referred to as “high gray-scale output (image) data” and the conversion data read from the second data storage 614 are referred to as “low gray-scale output (image) data.” These conversion data are different kinds of output image data.

The output image data are transmitted to the data driver 500 and are converted into data voltages (referred to as high gray-scale data voltage and low gray-scale data voltage) The high gray-scale data voltage and low gray-scale data voltage correspond to the high gray-scale output data and the low gray-scale output data, respectively. The converted data voltages are transmitted to the pixels (or the subpixel) through the data lines D₁ to Dₘ. The data voltages corresponding to the output image data are generated by the gray-scale voltage generator 800. In the present embodiment, the data voltages corresponding to the high gray-scale output data and the low gray-scale output data are generated by one gray-scale voltage generator 800. However, unlike the present embodiment, a gray-scale voltage generator for high gray-scale output data and a gray-scale voltage generator for low gray-scale output data may be individually provided, and the data voltages may be generated from the respective gray-scale voltage generators.

The high gray-scale data voltage and the low gray-scale data voltage are applied to neighboring pixels (or subpixels) every frame. It is preferable that the pixels (subpixels) supplied with the high gray-scale data voltage and the pixels (subpixels) supplied with the low gray-scale data voltage are supplied with a fixed data voltage. However, a specific kind of data voltage should be necessarily applied to specific pixels.

FIG. 4 shows a relationship between the output image data values and the gray scales. Here, G values indicate the values of the output image data. As the G value becomes greater, higher brightness can be displayed. In the present exemplary embodiment, 256 gray scales are exemplified.

First, the high gray-scale output data are explained. The excessive brightness region (L) exists in the high gray-scale output data. The high gray-scale output data in the gray scales corresponding to the excessive brightness region (L) have a G value greater than the G value of the high gray-scale output data in the highest gray scale (gray scale 255). As illustrated in FIG. 4, the high gray-scale output data in the highest gray scale (gray scale 255) has a G value of 230G, the high gray-scale output data in gray scale 222 has a G value of 253G, the high gray-scale output data in gray scale 223 has a G value of 254G, the high gray-scale output data in gray scale 224 has a G value of 255G, and the high gray-scale output data in gray scale 253 has a G value of 253G.

On the other hand, no excessive brightness region exists in the low gray-scale output data, as illustrated in FIGS. 3 and 4. As the gray scale becomes greater, the low gray-scale output data value (G value) also becomes greater. However, as can be seen from the low gray-scale gamma curve, a region where the low gray-scale output data value (G value) does not increase with increase in gray scale exists in the low gray-scale output data. As shown in FIG. 4, the low gray-scale output data in gray scales 2 to 4 have a fixed value of 2G. In this way, when the gray scale varies, the same low gray-scale output data can be supplied but the high gray-scale output data are supplied having different values. Accordingly, different brightness values are displayed with different gray scales.

As described above, the high gray-scale output data and the low gray-scale output data are converted into the high gray-scale data voltage and the low gray-scale data voltage, respectively, and then the high gray-scale data voltage and the low gray-scale data voltage are applied to the pixels or subpixels, the high gray-scale data voltage and the low gray-scale data voltage being different from each other.

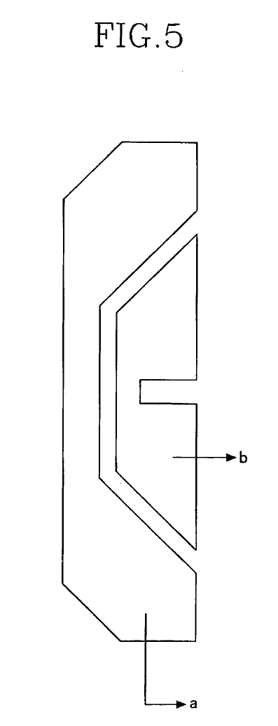

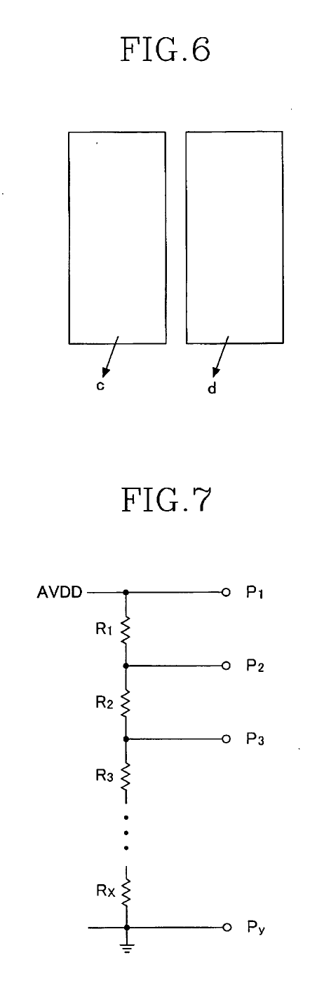

FIG. 5 shows a pixel structure in which different data voltages are applied to different subpixels of a pixel. FIG. 6 shows a pixel structure in which different data voltages are applied to two different pixels.

As shown in FIG. 5, a single pixel is illustrated as being divided into two subpixels, and the high gray-scale data voltage and the low gray-scale data voltage are applied to a respective subpixel a and b. When the high gray-scale data voltage is applied to the subpixel a, the low gray-scale data voltage is applied to the subpixel b. Of course, the subpixel supplied with the high gray-scale data voltage and the subpixel supplied with the low gray-scale data voltage can be interchanged with each other. In addition, the subpixel supplied with the high gray-scale data voltage may be changed every frame, but it is preferable that the subpixel once supplied with the high gray-scale data voltage is supplied with the high gray-scale data voltage and the other subpixel is supplied with the low gray-scale data voltage for every frame.

On the other hand, as shown in FIG. 6, the high gray-scale data voltage and the low gray-scale data voltage are applied to the pixel electrodes of two neighboring pixels c and d, respectively. When the high gray-scale data voltage is applied to the pixel c, the low gray-scale data voltage is applied to the pixel d. Of course, the pixel supplied with the high gray-scale data voltage and the pixel supplied with the low gray-scale data voltage can be interchanged with each other. In addition, the pixel supplied with the high gray-scale data voltage may be changed every frame, but it is preferable that the pixel once supplied with the high gray-scale data voltage is supplied with the high gray-scale data voltage and the other pixel is supplied with the low gray-scale data voltage for every frame.

The G value, which is a value of the output image data, is now explained in further detail below. The G value is a value obtained by dividing a voltage, which should be applied to display the highest brightness corresponding to gray scale H (highest brightness gray scale) for displaying the highest brightness in the high gray-scale gamma curve, into 256 gray scales. As a result, a total of 256 G values exist (from 0G to 255G). The high gray-scale output data in the highest brightness gray scale (gray scale H) have 255G and the high gray-scale output data in the highest gray scale (gray scale 255) have 230G (see FIG. 4).

In order to apply the above-mentioned voltages, the magnitude of the voltage, which can be generated from the gray-scale voltage generator 800, should increase. FIG. 7 is a circuit diagram illustrating the gray-scale voltage generator 800 in accordance with an exemplary embodiment. As shown in FIG. 7, the gray-scale voltage generator 800 divides an AVDD voltage with a plurality of resistors R₁, R₂, . . . , Rₓ and generates gray scale voltages. The divided AVDD voltage can be measured through the terminals P₁, P₂, . . . , P_{y}. The number of resistors and the number of terminals may be combined in a variety of methods, and the number of terminals may not correspond to the number of gray scales (256) that can be displayed by the liquid crystal display. In addition, the AVDD voltage may not be the voltage value in gray scale H (highest brightness gray scale).

In exemplary embodiments of the present invention, the highest brightness gray scale (gray scale H) can be displayed by enhancing the AVDD voltage. As a result, the brightness of the liquid crystal display does not drop as a whole.

Here, it is preferable that the AVDD voltage is set to the highest value in the range permitted by the data driver 500.

On the other hand, the image data for one pixel (or subpixel) may be converted once into the image data having a positive polarity with respect to the common voltage and may be output. Subsequently, the image data for the pixel (or subpixel) may be converted into the image data having a negative polarity with respect to the common voltage and may be output (inversion driving). In addition, by increasing the output frame frequency to double the input frame frequency, it is possible to make the output frame frequency different and to recognize the difference between the high gray-scale output data and the low gray-scale output data with the naked eye.

Unlike the embodiment described above, instead of conversion of the input image data, two gray-scale voltage sets may be generated. In this case, the high gray-scale data voltage and the low gray-scale data voltage are generated by the use of the two gray scale voltage sets, and then the high gray-scale data voltage and the low gray-scale data voltage may be applied to the pixels (or subpixels). The gamma curves expressed by the two gray scale voltage sets for the input image data are equal to the high gray-scale gamma curve T1 and the low gray-scale gamma curve T2 shown in FIG. 3. In this case, instead of converting the input image data into the high gray-scale output image data and the low gray-scale output image data, the signal controller 600 generates a control signal for generating and applying two gray scale voltage sets to the pixels (or subpixels) and supplies the control signal to the data driver 500. The data driver 500 converts the image data into the gray scale voltages selected from the two gray scale voltage sets in response to the control signal and then outputs the gray scale voltages as the data voltages.

As described above, it is possible to enhance the difference between the brightness displayed with the low gray-scale output data and the brightness displayed with the high gray-scale output data by dividing the input gray-scale data into the high gray-scale output data and the low gray-scale output data and allowing brightness higher than the brightness in the highest gray scale to be displayed by the use of the high gray-scale output data. Accordingly, the side visibility of a display is enhanced and the display characteristics of a display are improved.

In addition, by enhancing the AVDD voltage applied to the gray-scale voltage generator, it is possible to prevent the brightness of the display from decreasing as a whole.

Although the exemplary embodiments of the present invention have been described, the present invention is not limited to the exemplary embodiments described herein, but may be modified in various forms without departing from the scope of the appended claims, the detailed description, and the accompanying drawings of the present invention. Therefore, it is natural that such modifications belong to the scope of the present invention.

What is claimed is:

1. A driving device of a display having a plurality of pixels arranged in a matrix, each pixel having a pixel electrode, the driving device comprising:
a signal controller configured to receive input image data and convert the input image data into first output image data having a gray scale higher than the gray scale of the input image data and second output image data having a gray scale lower than the gray scale of the input image data; and
a data driver configured to converting the first and second output image data from the signal controller into first and second data voltages, respectively, and apply the first and second data voltages to the corresponding pixels,
wherein the first output image data include data for displaying brightness higher than the brightness in the highest gray scale.

2. The driving device of claim 1, wherein the first output image data and the second output image data are supplied to neighboring pixel electrodes every frame.

3. The driving device of claim 1, wherein each pixel electrode is divided into a first subpixel electrode and a second subpixel electrode, and
the first output image data and the second output image data are supplied to the first subpixel electrode and the second subpixel electrode, respectively, for every frame.

4. The driving device of claim 1, further comprising a gray-scale voltage generator for dividing an input AVDD voltage with a resistor and generating a gray scale voltage,
wherein the AVDD voltage is higher than the gray scale voltage in the highest gray scale.

5. The driving device of claim 4, wherein the gray-scale voltage generator includes a section for generating a gray scale voltage for the first output image data and a section for generating a gray scale voltage for the second output image data.

6. A driving device of a display having a plurality of pixels arranged in a matrix, each pixel having a pixel electrode, the driving device comprising:
a signal controller for converting input image data into output image data and outputting the output image data;
a first gray-scale voltage generator configured to generate a gray scale voltage by dividing a first AVDD voltage with a first resistor and generate a first gray scale voltage to display a first gray scale higher than the gray scale of the input image data;
a second gray-scale voltage generator configured to generate a gray scale voltage by dividing a second AVDD voltage with a second resistor and generate a second gray scale voltage to display a second gray scale lower than the gray scale of the input image data; and
a data driver for converting the first and second gray scale voltages from the first gray-scale voltage generator and the second gray-scale voltage generator into first and second data voltages, respectively, on the basis of the output image data from the signal controller and applying the first and second data voltages to the corresponding pixels,
wherein the first gray scale voltage has a voltage value for displaying brightness higher than the brightness in the highest gray scale.

7. The driving device of claim 6, wherein the first data voltage and the second data voltage are applied to neighboring pixel electrodes every frame.

8. The driving device of claim 6, wherein each pixel electrode is divided into first and second subpixel electrodes, and
the first data voltage and the second data voltage are applied to the first and second subpixel electrodes, respectively, for every frame.

9. The driving device of claim 6, wherein the first AVDD voltage is higher than the gray scale voltage in the highest gray scale.

10. A driving device of a display having a plurality of pixels arranged in a matrix, each pixel having a pixel electrode, the driving device comprising:
a signal controller configured to convert input image data into output image data and output the output image data;
a gray-scale voltage generator configured to generate a gray scale voltage by dividing an AVDD voltage with a resistor; and
a data driver configured to convert the gray scale voltage from the gray-scale voltage generator into first and second data voltages on the basis of the output image data from the signal controller and apply the first and second data voltages to the corresponding pixels,
wherein the first data voltage has a voltage value displaying brightness higher than the brightness in the highest gray scale.

11. A method for driving a display having a plurality of pixels arranged in a matrix, each pixel having a pixel electrode, the method comprising:
receiving input image data;
converting the input image data into first output image data having a gray scale higher than the gray scale of the input image data and second output image data having a gray scale lower than the gray scale of the input image data;
converting the first and second output image data into first and second data voltages; and
applying the first and second data voltages to the corresponding pixels,
wherein the first output image data include data for displaying brightness higher than the brightness in the highest gray scale.

12. The method of claim 11, further comprising supplying the first output image data and the second output image data to neighboring pixel electrodes every frame.

13. The method of claim 11, further comprising supplying the first output image data and the second output image data to a first subpixel electrode and a second subpixel electrode, respectively, for every frame,
wherein each pixel electrode is divided into the first subpixel electrode and the second subpixel electrode.

14. The method of claim 11, further comprising:
dividing an input AVDD voltage with a resistor; and
generating a gray scale voltage,
wherein the AVDD voltage is higher than the gray scale voltage in the highest gray scale.

15. A method for driving a display having a plurality of pixels arranged in a matrix, each pixel having a pixel electrode, the method comprising:
converting input image data into output image data;
outputting the output image data;
generating a gray scale voltage by dividing a first AVDD voltage with a resistor and generating a first gray scale voltage for displaying a gray scale higher than the gray scales of the input image data;
generating a gray scale voltage by dividing a second AVDD voltage with a resistor and generating a second gray scale voltage for displaying a gray scale lower than the gray scale of the input image data; and
converting the first and second gray scale voltages from the first gray-scale voltage generator and the second gray-scale voltage generator into first and second data voltages on the basis of the output image data; and
applying the first and second data voltages to the corresponding pixels,
wherein the first gray scale voltage has a voltage value for displaying brightness higher than the brightness in the highest gray scale.

16. The method of claim 15, further comprising applying the first data voltage and the second data voltage to neighboring pixel electrodes every frame.

17. The method of claim 15, further comprising:
dividing each pixel electrode into first and second subpixel electrodes; and
applying the first data voltage and the second data voltage to the first and second subpixel electrodes, respectively, for every frame.

18. The method of claim 15, wherein the first AVDD voltage is higher than the gray scale voltage in the highest gray scale.

19. A method for driving a display having a plurality of pixels arranged in a matrix, each pixel having a pixel electrode, the method comprising:
converting input image data into output image data;
outputting the output image data;
generating a gray scale voltage by dividing an AVDD voltage with a resistor; and
converting the gray scale voltage into first and second data voltages on the basis of the output image data; and
applying the first and second data voltages to the corresponding pixels,
wherein the first data voltage has a voltage value for displaying brightness higher than the brightness in the highest gray scale.
